(19) United States
(12) Patent Application Publication
(10) Pub. No.: US 2012/0296846 A1
(43) Pub. Date: Nov. 22, 2012

(54) SYSTEM FOR MODELING INVESTMENT PERFORMANCE

(75) Inventor: Robert Teeter, New York, NY (US)

(73) Assignee: TEN-SIXTY ASSET MANAGEMENT, New York, NY (US)

(21) Appl. No.: 13/376,257

(22) PCT Filed: Jun. 2, 2010
(86) PCT No.: PCT/US10/37036

§ 371 Date: Aug. 3, 2012

Related U.S. Application Data
(60) Provisional application No. 61/183,855, filed on Jun. 3, 2009.

(51) Int. Cl. G06Q 40/06

(52) U.S. Cl. 705/36 R

(57) ABSTRACT

A system for simulating investment performance using computerized models. Inputs to an investment model may be derived from information published about the investment, information published about the investment manager, industry practices corresponding to the particular type of investment, etc. Model accuracy may then be verified by comparing simulated investment performance over a duration of time to actual investment performance over the same period. Disparities in actual and simulated performance may be resolved by adjusting the model, which may further comprise modifying the composition of model elements that replace questionable or unknown investment components in view of information that is known about the investment.

This international application is based on and claims priority to U.S. Provisional Application Ser. No. 61/183,855, filed on Jun. 3, 2009, entitled, “System for Modeling Investment Performance,” and of which the entire contents herein is incorporated by reference.

### BACKGROUND

1. Field of Invention

Various embodiments of the present invention relate to investment analysis, and in particular, to a system that may utilize models to simulate the performance of an investment.

2. Background

Current investment analysis is mostly a retrospective process based on available performance information. Analysts may utilize past performance measurements to evaluate historical management decisions, current investment “health” or to predict future performance. The results of this analysis may, in turn, be utilized in managing a portfolio of investments, in advising clients, in performing due diligence regarding an investment manager and/or firm, etc.

In view of the above method of operation, the accuracy of investment analysis becomes unavoidably dependant upon the amount of investment data that is available to input into analytical tools. Investments that are able to, or elect to, provide statistical information such as the identification of individual components that comprise an investment vehicle (e.g., stocks that make up a mutual fund), the percentage of an investment that resides in various risk types or categories, the strategy of the investment manager, etc., will presumably allow for more accurate analysis. On the contrary, investment vehicles whose management decides to keep information confidential (e.g., as proprietary investment strategies) force investors to rely solely on unknown activities occurring “behind the scenes.” This lack of insight into investment composition may result in unexpected performance that could prove extremely detrimental to client assets.

For example, the various investments that constitute hedge funds are often kept confidential. Potential and existing investors are therefore forced to rely upon limited published performance and/or strategy information that is provided by the manager of the fund. This lack of component disposition and volume information may hinder the ability of investors to analyze and/or investigate perceived discrepancies in performance. In particular, investors or investment managers cannot perform independent investment performance analysis, and therefore, cannot make objective decisions regarding investment management (e.g., to invest more, sell or hold).

Moreover, reported past performance information for investments comprised of multiple components (e.g., mutual or hedge funds) where specific composition information is not available only provide accumulated changes in overall investment performance based on the unknown composition of the investment at that time. As past performance may not be indicative of future return, especially where the investment composition could be changing without the knowledge of investors, the opportunity to avoid potentially problematic situations is impeded.

### SUMMARY

Various embodiments of the present invention are directed to a method, computer program product and system for simulating investment performance using computerized models. Inputs to an investment model may be derived from information published about the investment, information published about the investment manager, industry practices corresponding to the particular type of investment, etc. Model accuracy may then be verified by comparing simulated investment performance over a duration of time to actual investment performance over the same period. Disparities in actual and simulated performance may be resolved by adjusting the model. After the desired level of accordance is realized, a model may be utilized for various applications including, for example, determining if investment composition has changed, verifying accuracy of management reports, as information for querying investment managers, advising clients on potential courses of action, making buy/sell/hold decisions, modeling future performance, etc.

In accordance with at least one implementation of the present invention, model creation may include the selection of various financial components in an attempt to duplicate the composition of the actual investment. These financial components may either be directly input as known components (e.g., publicly identified by the investment manager) or may be unknown to the end investor. For example, in a scenario where the investment is a hedge fund, some or all of the investment components that make up the fund may not be publicly disclosed. In situations where some or all of the investment components are indefinite or even unknown, model elements representing possible investment components may be inserted in place of known components based on what information is available about the investment. Further simulation may be used to confirm the accuracy of the model elements, and any disparities between actual and simulated performance may be remedied by adjusting composition for one or more of the model elements.

For example, a model element may include one or more financial instruments. Existing model elements (e.g., from previous models) may be utilized in new models, or new model elements may be created. The financial instruments selected for each model element may be based on what is known about the investment, what is known about the investment manager, general knowledge regarding industry practice, etc. For example, model elements may comprise a group of representative financial instruments that result from a process that selectively chooses a representative body of investments corresponding to an overall type, group, category, etc.

The above summarized configurations or operations of various embodiments of the present invention have been provided merely for the sake of explanation, and therefore, are not intended to be limiting. Moreover, inventive elements associated herein with a particular example embodiment of the present invention can be used interchangeably with other example embodiments depending, for example, on the manner in which an embodiment is implemented.

### DESCRIPTION OF DRAWINGS

Various embodiments of the present invention will be further understood from the following detailed description including example implementations and/or configurations of the various embodiments when taken in conjunction with appended drawings, in which:

FIG. 1 discloses an example of a computer and communication system with which the various embodiments of the present invention may be enabled or implemented.

FIG. 2 discloses a flowchart depicting an example of a typical investment management process.

FIG. 3 discloses further detail regarding elements of the flowchart of FIG. 2 with respect to example process steps for analyzing investments based solely upon past performance.

FIG. 4 discloses a flowchart of an example process in accordance with at least one embodiment of the present invention.

FIG. 5 discloses further detail regarding elements of the flowchart of FIG. 4 with respect to an example model creation process in accordance with at least one embodiment of the present invention.

FIG. 6 discloses an example of the selection of financial instruments for a model element in accordance with at least one embodiment of the present invention.

FIG. 7 discloses a flowchart of an example utilization process in accordance with at least one embodiment of the present invention.

### DESCRIPTION OF EXAMPLE EMBODIMENTS

While the present invention has been described herein in terms of a multitude of example embodiments, various changes or alterations can be made therein without departing from the spirit and scope of the present invention, as set forth in the appended claims.

I. Example System with which Embodiments of the Present Invention may be Implemented

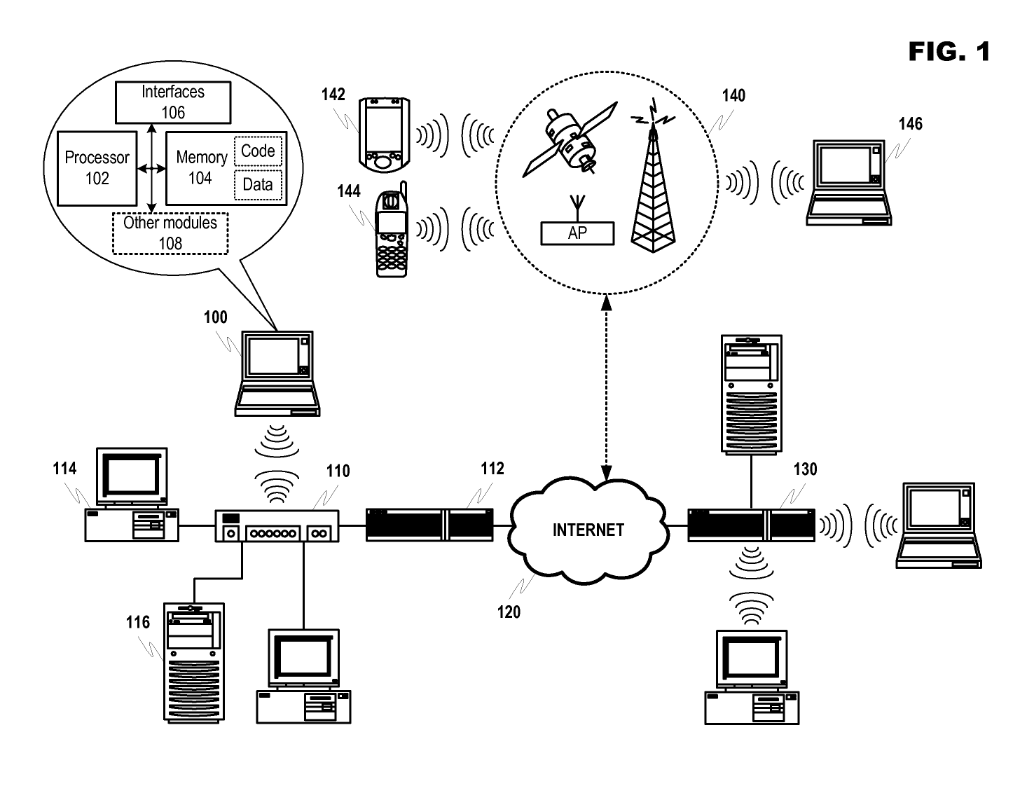

An example of a system that is usable for implementing various embodiments of the present invention is disclosed in FIG. 1. The system comprises elements that may be included in, or omitted from, configurations depending, for example, on the requirements of a particular application, and therefore, is not intended to limit present invention in any manner.

Computing device 100 may be, for example, a laptop computer. Elements that represent basic example components comprising functional elements in computing device 100 are disclosed at 102-108. Processor 102 may include one or more devices configured to execute instructions, wherein a group of instructions may be constituted, for example, as program code. In at least one scenario, the execution of program code may include receiving input information from other elements in computing device 100 in order to formulate an output (e.g., data, event, activity, etc). Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or embedded memories that operate in a static or dynamic mode. Further, memory 104 may include read only memories (ROM), random access memories (RAM), and rewritable memories such as Flash, EPROM, etc. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 100 may provide wired and/or wireless support to devices such as computer 114 and server 116. Hub 100 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

### II. Investment Management Based Solely on Past Performance

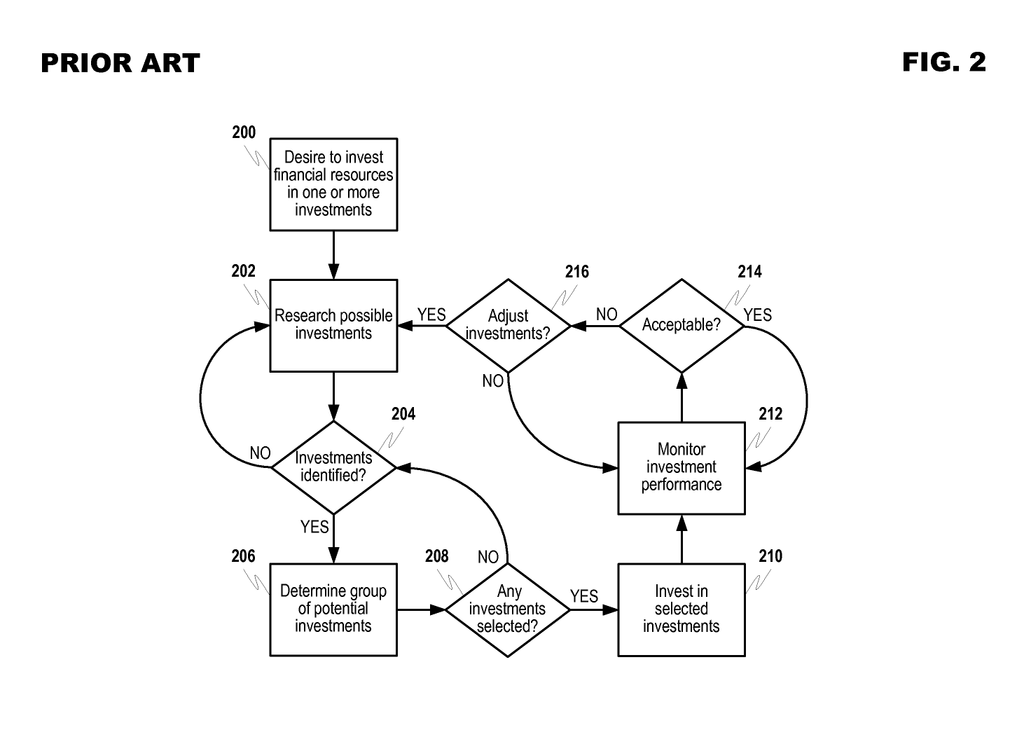

FIG. 2 discloses an example of an investment management strategy in accordance with existing practices. In a typical scenario, the desire of a client to place available capital into one or more investments (e.g., wherein the one or more investments may constitute a portfolio) in step 200 may result in an investment manager (e.g., a person or firm contracted to manage the finances of individuals, group of individuals, corporate entity, etc.) researching appropriate investments for the client to consider in view of client-related parameters (step 202). Client-related parameters may include the amount of capital to invest, the goals of the client, the amount of risk a client is willing to take, client characteristics (age, familial status, trustee status, etc.) This process may continue in step 204 until investments have been identified. The investments identified in step 204 may be further narrowed to a group of potential investments in step 206. This narrowing may be based on the analysis of past performance, the strategy of the investment manager, the amount of risk, etc. in view of the client-related parameters. Selection of one or more investments in the group of potential investments may then take place in step 208. An example scenario might comprise an investment manager presenting the group of investments to the client, discussing each investment, and assisting the client during selection. In situations where none of the group of investments are selected, the process may revert to step 204 wherein additional (e.g., possibly using different parameters) research may identify new investments.

If in step 208 one or more investments are selected, the client's available capital may be invested in the selected financial instruments. A management process may then began in step 212 wherein the performance of the one or more investments may be tracked. Monitoring may comprise, for example, the analysis of reported performance data for each investment. A determination may then be made in step 214 as to whether the performance of the one or more investments is acceptable. If the performance is acceptable, the process may continue to track performance in step 212. If the performance is not acceptable, then a determination may be made in step 216 as to whether the portfolio (e.g., the one or more investments) needs to be adjusted. If, for example, the current poor performance is deemed to be a temporary aberration, then no action may be taken and monitoring may continue in step 212. Alternatively, a decision may be made that further research is required (e.g., the process may return to step 202) in order to, for example, determine whether a change should be made to a more appropriate investment.

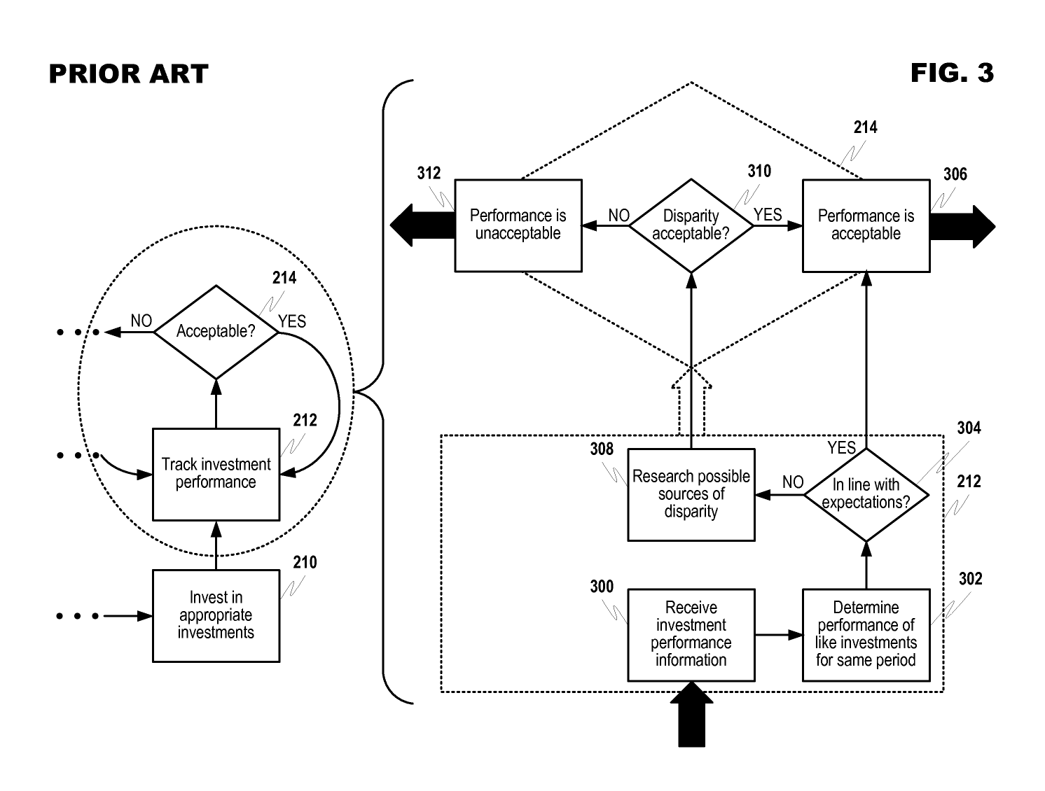

When the benefits and weaknesses of the example management strategy disclosed in FIG. 2 are considered, it becomes apparent that this reactive approach has limitations that may potentially impact return on the investment. These weaknesses will be explored with respect to FIG. 3, which contains further detail on steps 212 and 214 that were previously disclosed in FIG. 2. Steps 300-312 are sub-processes that may occur during the tracking and determination of acceptability that occurs in existing management strategies. Performance information for one or more investments that is received in step 300 may be compared to the performance of similar investments for the same period of time. If in step 304 a determination is made that the performance is in line with expectations (based, for example, on the performance of similar investments), then in step 306 the performance of the one or more investments may be deemed acceptable, and the process may continue monitoring in step 212 as shown in FIG. 2. However, if the performance of the one or more investments is not in line with expectations, then research may commence in step 308 in order to determine possible sources for the disparity. This inquiry may be based, for example, on available historical investment performance data, investment composition information, strategy information provided by the investment manager, etc. In view of this research, a determination may then be made in step 310 as to whether the disparity is acceptable. If acceptable, the process may move to step 306 and proceed as described above. Otherwise, the process may move to step 312, which is followed by step 216 as shown in FIG. 2.

Weaknesses that become apparent in the representative process of FIG. 2-3 are related to reliance solely upon historical performance when attempting to manage investments. Historical performance records activity that has already occurred based on the composition of an investment at the time of monitoring. For investments where some or all of the components are not disclosed, performance information alone does not allow investors to understand investment composition both then and now, whether changes in composition and/or management strategy have occurred, or understand how the current composition of investments will be impacted by market forces. Investors may therefore be prevented from acting proactively to investigate and possibly avoid problematic situations.

A more proactive strategy may allow investors to understand current composition of investments, and in view of these current holdings, to ask, “why . . . ” or “what if . . . ” in view of perceived trends in a market. This information may, for example, allow investors to create contingency plans for various scenarios. In the case of investments like hedge funds where the actual composition of the fund may not be publicly disclosed, the investor is then at the mercy of the fund manager for information and explanations regarding fund performance. This lack of visibility may lead investors to make incorrect assumptions about investment composition, and as a result, investors may not be able to reliably predict and avoid problems that would have been readily apparent given a better understanding of the financial disposition of the investment.

### III. Creating Accurate Investment Models

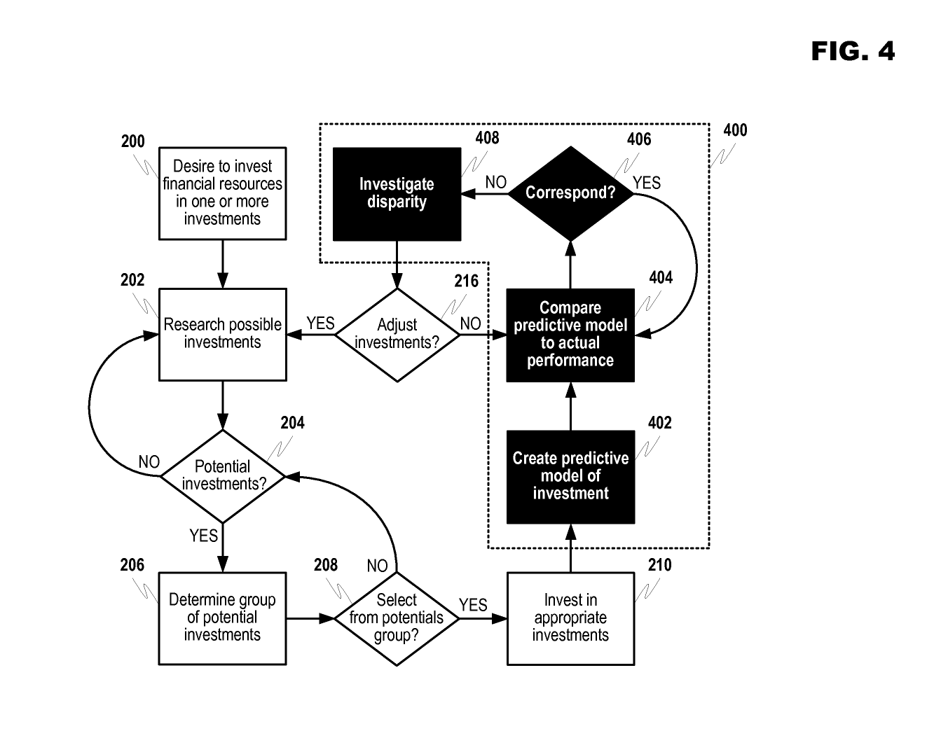

In accordance with at least one embodiment of the present invention, an analysis system that provides both the ability to proactively manage one or more investments and to have insight into the contents of an investment that does not provide composition information is now disclosed with respect to FIG. 4. Modeling and analysis process 400 may comprise at least steps 402-408. For example, one or more compositional models may be created in step 402 that correspond to each of the one or more investments in which capital is allocated in step 210. The compositional models may be utilized to replicate the composition of investments where, for example, some or all of the components of investments are unknown. Compositional models may then be used for various simulation purposes including, but not limited to, verifying that investment performance is in line with expectations, predict future investment performance, etc.

For example, performance simulated by a compositional model corresponding to a certain period of time may be compared to the actual reported performance of the investment over the same period in step 404. If the actual and simulated performance correspond to each other (step 406), then monitoring continue in step 404. However, if actual performance does not match the simulated performance, then in step 408 and investigation may be made into the potential causes of the disparity. For example, the simulated investment information may be utilized in support of an inquiry to the manager of an investment (e.g., hedge fund manager) regarding perceived performance anomalies. The analysis resulting from steps 406 and 408 may further be reported to clients (or shown to potential clients) to provide insight into investment performance for investments that do not disclose component and/or strategy information.

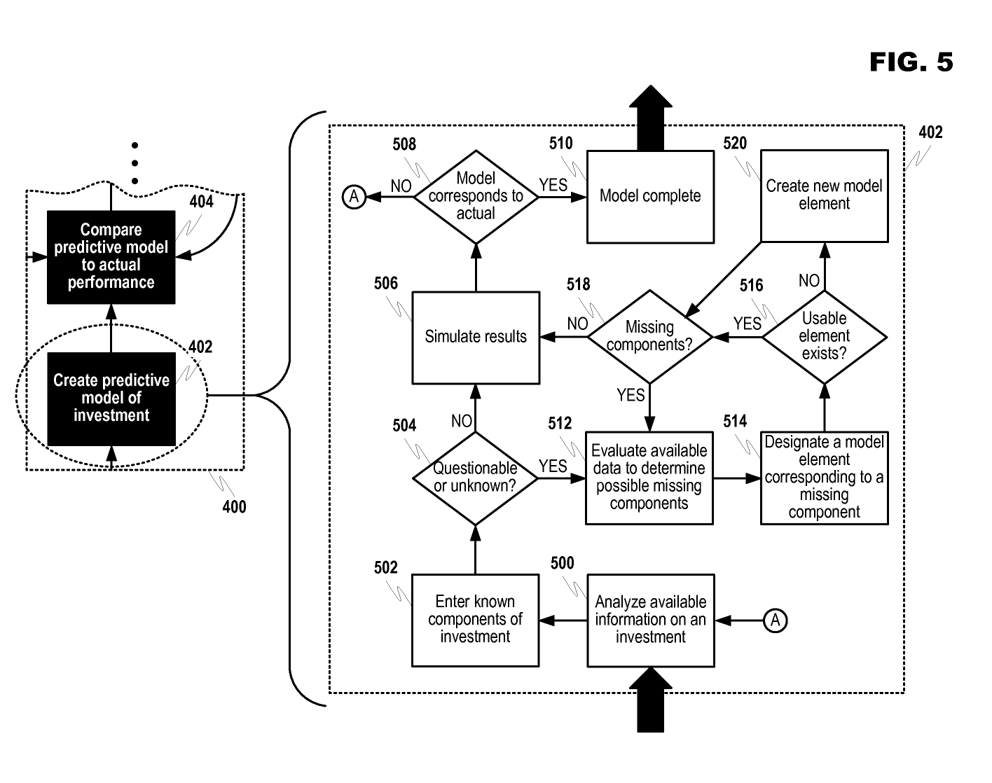

An example showing how a predictive model may be created, in accordance with at least one example embodiment of the present invention, is disclosed in FIG. 5. A creation process that may be utilized in step 402 is provided in detailed steps 500-508. Available data regarding an investment may be analyzed in step 500. Available data may include, but is not limited to, performance information, information on the manager and what is known about the possible management strategies, the general type or category of investment, marketing materials including the general description of the fund with respect to types of holdings, aggressiveness, etc. The analysis of step 500 may yield, for example, known components of the investment and components of the investment that may be questionable or unknown. The known components may be entered into the model in step 502. A decision may then be made in step 504 regarding whether one or more of the investment components are questionable or unknown. In situations where the identity of all investment components are believed to be readily apparent, the process may proceed to step 506 wherein the model may be used to simulate investment performance over a period of time. In step 508, the simulated investment performance may be compared to actual investment performance over the same period of time. If the results match (e.g., include an acceptable degree of variance), then in step 510 the model may be considered complete. Otherwise, if the results include an unacceptable amount of variance, then the process may return to step 500 to correct any errors or incorrect assumptions made in the initial analysis.

If one or more components of the investment are determined to questionable or unknown in step 504, the available information about the investment may be utilized in step 512 to characterize the nature of the missing components. The characteristics of the questionable or unknown investment component may be utilized to define a model element in step 514. A determination may be made in step 516 as to whether an any existing model elements (e.g., from a prior investment analysis) correspond to the characteristics defined in steps 512 and 514. If an existing model element is determined to correspond closely enough (e.g., within an acceptable degree of variance) to the characteristics of the questionable or unknown component, then this model component may be added to the model and an inquiry is made as to whether there are any further questionable or unknown investment components (step 518). If questionable or unknown investment components for which a model element has not been assigned still remain, then the process may continue in step 512 to create the next model element. If no further model elements need to be assigned, then the process may simulate the performance of the investment and compare the simulated results to the actual results for the same time period (e.g., steps 506-510).

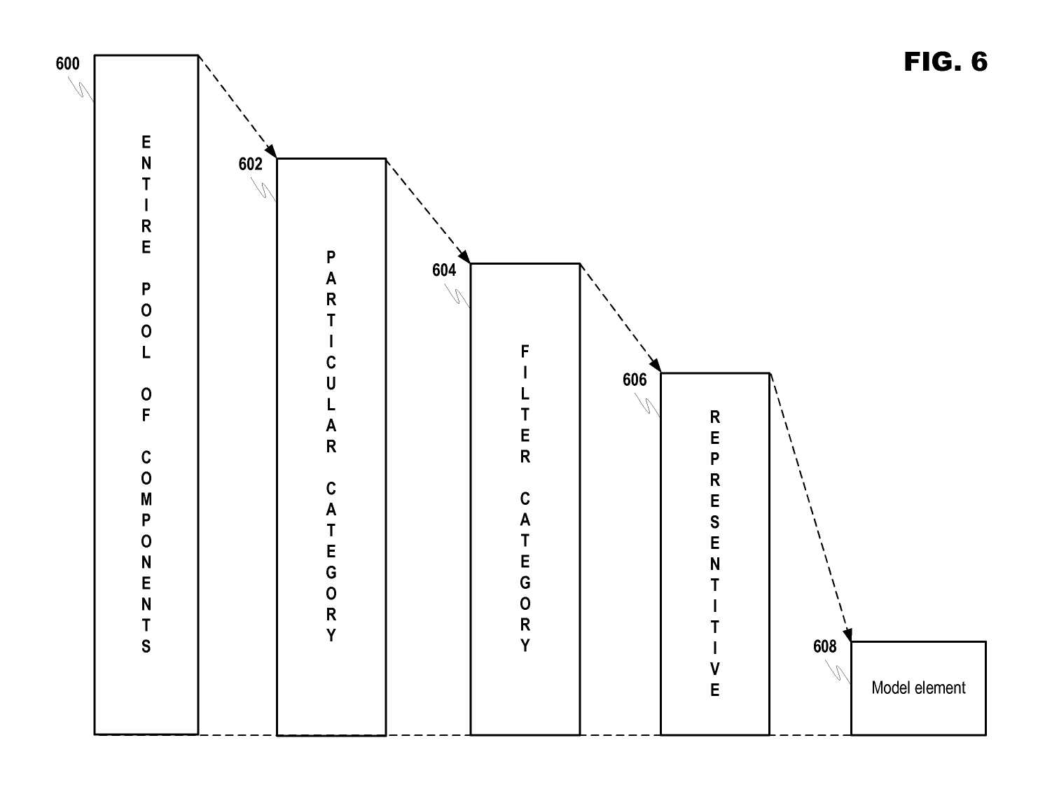

If in step 516 a determination is made that no usable model element exists, then in step 520 a model element may be created. An example of model element creation is disclosed in FIG. 6, wherein the entire pool of possible investment components 600 may be refined down to a model element based on the presumed characteristics of a questionable or unknown investment component. For instance, the entire pool of possible investment components may be limited to a particular category of investment components at 602. The investment component category may be further filtered, as shown at 604, based on the characteristic information established in steps 512 and 514. For example, characteristics like the aggressiveness of an investment may dictate the inclusion of certain investment components in, or the elimination of certain investment components from, the overall category. Other characteristics usable in the filtering process may include, but are not limited to, the particular industry area, the goal of the investment, past decisions by the investment manager, etc. Representative investment components may then be selected that are believed to best reflect the characteristics of the questionable or unknown investment component, as shown at 606, and some or all of these representative investment components may be utilized to create model element 608.

The process of FIG. 5 may then return to 516 to determine if any further investment components are questionable or unknown. In accordance with various embodiments of the present invention, the process of FIG. 5 may continue to iterate until the simulated performance is within an acceptable variance of the actual performance. This iteration process may occur regardless of whether all the components of an investment are presumed to be known, as it is possible that the available investment information may intentionally be confusing as to mask the true structure of the investment from those who would try to duplicate the strategy.

### IV. Example Implementation

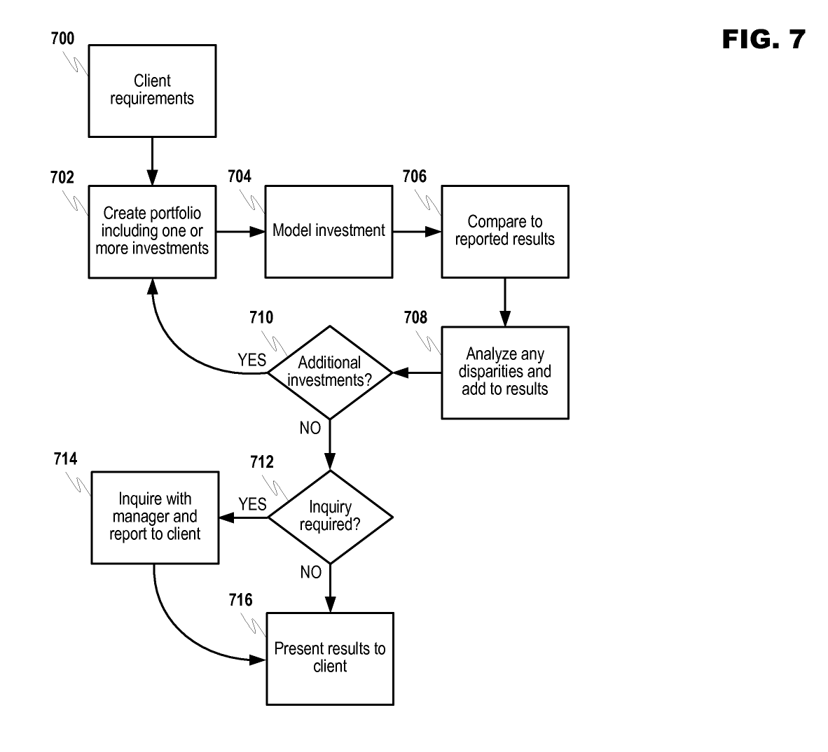

Now referring to FIG. 7, an example implementation that may utilize the various embodiments of the present invention is now disclosed. In step 700 an investment manager may identify the requirements of a client. The investment manager may then create a portfolio that, for example, contains one or more investments, to meet the client's needs. In accordance with at least one embodiment of the present invention, each investment in the portfolio may be modeled in step 704 and the simulated results over a duration of time may then be compared to the actual performance of the investment over the same time period in step 706. Analysis of disparities that may exist between simulated and actual results may then be analyzed and added to the reporting for the overall portfolio in step 708. This process of simulation, comparison and analysis may continue in step 710 until the analysis is complete for each investment in the portfolio.

When analysis is complete for all investments in the portfolio, a decision may be made in view of any discrepancies noted in the one or more investments as to whether an inquiry to the investment manager should occur before reporting out the results. If an inquiry is deemed necessary or appropriate, an inquiry as to why a perceived disparity exists for some or all of the investments that demonstrate a difference between simulated and actual performance may be made in step 714. The results of the inquiry (e.g., the explanation from the investment manager), an analysis of the inquiry results (e.g., whether the explanation from the investment manager appears accurate), a proposed course of action (e.g., buy sell or hold), etc. may then be presented to the client in step 716 in the form of, for example, a letter, report, prospectus, meeting, etc.

While various exemplary configurations of the present invention have been disclosed above, the present invention is not strictly limited to the previous embodiments.

For example, the present invention may include, in accordance with at least one exemplary embodiment, a method and/or an apparatus comprising at least one processor and at least one memory including computer executable instructions configured to, in cooperation with the at least one processor, cause the apparatus to perform the method comprising selecting an investment, the investment comprising one or more components; determining whether any of the one or more components are known; entering the known components into a model; creating a model element corresponding to each of the one or more components that are determined to be unknown and entering the model element; simulating performance for the investment utilizing the model; comparing the simulated investment performance to actual performance for the investment over the same duration of time; and adjusting the model to reduce any disparity between the simulated investment performance and the actual investment performance.

The prior example of a method in accordance with at least one embodiment of the present invention may further comprise determining whether any of the one or more components are known comprises reviewing information provided by managers of the investment.

The prior example of a method in accordance with at least one embodiment of the present invention may further comprise the model element comprising one or more financial instruments. In addition, this example method may include creating a model element further comprises selecting the one or more financial instruments based on at least one of available information regarding the investment, past investment performance or industry practice information. In addition, this example method may include adjusting the model comprises changing at least one of the one or more financial instruments in a model element and re-simulating performance for the investment utilizing the model.

The prior example of a method in accordance with at least one embodiment of the present invention may further comprise presenting the simulated investment performance to a client in conjunction with the actual investment performance. In addition, this example method may include presenting analysis of disparities between the simulated investment performance and actual investment performance to the client.

The prior example of a method in accordance with at least one embodiment of the present invention may further comprise, further comprising creating a portfolio, the portfolio comprising one or more investments. In addition, this example method may include creating a model for each investment in the portfolio and presenting simulated investment performance for the portfolio to the client in conjunction with actual portfolio performance. The subsequent example method may further include presenting analysis of disparities between the simulated portfolio performance and actual portfolio performance to the client.

In addition to the above example method the present invention may comprise, in accordance with at least one exemplary embodiment, a computer program product comprising computer executable program code recorded on a computer readable storage medium, the computer executable program code comprising: computer programmable program code configured to determine whether any of one or more components included in an investment are known; computer programmable program code configured to enter the known components into a model; computer programmable program code configured to create a model element corresponding to each of the one or more components that are determined to be unknown and entering the model element; computer programmable program code configured to simulate performance for the investment utilizing the model; computer programmable program code configured to compare the simulated investment performance to actual performance for the investment over the same duration of time; and computer programmable program code configured to adjust the model to reduce any disparity between the simulated investment performance and the actual investment performance.

The prior example of a computer program product in accordance with at least one embodiment of the present invention may further comprise determining whether any of the one or more components are known comprises reviewing information provided by managers of the investment.

The prior example of a computer program product in accordance with at least one embodiment of the present invention may further comprise the model element comprising one or more financial instruments. In addition, this example computer program product may include creating a model element further comprises selecting the one or more financial instruments based on at least one of available information regarding the investment, past investment performance or industry practice information. In addition, this example computer program product may include adjusting the model comprises changing at least one of the one or more financial instruments in a model element and re-simulating performance for the investment utilizing the model.

The prior example of a computer program product in accordance with at least one embodiment of the present invention may further comprise presenting the simulated investment performance to a client in conjunction with the actual investment performance. In addition, this example computer program product may include presenting analysis of disparities between the simulated investment performance and actual investment performance to the client.

The prior example of a computer program product in accordance with at least one embodiment of the present invention may further comprise, further comprising creating a portfolio, the portfolio comprising one or more investments. In addition, this example computer program product may include creating a model for each investment in the portfolio and presenting simulated investment performance for the portfolio to the client in conjunction with actual portfolio performance. The subsequent example computer program product may further include presenting analysis of disparities between the simulated portfolio performance and actual portfolio performance to the client.

Accordingly, it will be apparent to persons skilled in the relevant art that various changes in forma and detail can be made therein without departing from the spirit and scope of the invention. The breadth and scope of the present invention should not be limited by any of the above-described example embodiments, but should be defined only in accordance with the following claims and their equivalents.

What is claimed:

1. A method, comprising
identifying an investment, the investment comprising one or more components;
determining whether each of the one or more components are known or unknown;
formulating a model of the investment in a computing device by entering the known components into the model of the investment;
creating a model element corresponding to each unknown component using the computing device and entering the model element into the model of the investment;
simulating performance for the investment in the computing device utilizing the model of the investment;
comparing the simulated investment performance to actual performance for the investment over the same duration of time using the computing device; and
adjusting the model to reduce any disparity between the simulated investment performance and the actual investment performance.

2. The method of claim 1, wherein determining whether each of the one or more components are known or unknown comprises reviewing information provided by managers of the investment.

3. The method of claim 1, wherein the model elements comprise one or more financial instruments.

4. The method of claim 3, wherein creating the model element comprises selecting the one or more financial instruments based on at least one of available information regarding the investment, past investment performance or industry practice information.

5. The method of claim 3, wherein adjusting the model comprises changing at least one of the one or more financial instruments in a model element and re-simulating performance for the investment utilizing the model.

6. The method of claim 1, further comprising presenting the simulated investment performance to a client in conjunction with the actual investment performance.

7. The method of claim 6, further comprising presenting analysis of disparities between the simulated investment performance and the actual investment performance to the client.

8. The method of claim 1, further comprising creating a portfolio, the portfolio comprising one or more investments.

9. The method of claim 8, wherein creating the portfolio comprises creating a model for each investment in the portfolio and presenting simulated investment performance for the portfolio to the client in conjunction with actual portfolio performance.

10. The method of claim 9, further comprising presenting analysis of disparities between the simulated portfolio performance and actual portfolio performance to the client.

11. A computer program product comprising computer executable program code recorded on a computer readable storage medium, the computer executable program code comprising:
code configured to cause a computing device to request identification of an investment, the investment comprising one or more components;
code configured to cause the computing device to request determination of whether each of the one or more components are known or unknown;
code configured to cause the computing device to formulate a model of the investment by requesting entry of the known components into the model of the investment;
code configured to cause the computing device to request creation of a model element corresponding to each unknown component and entry of the model element into the model of the investment;
code configured to cause the computing device to simulate performance for the investment utilizing the model of the investment;
code configured to cause the computing device to compare the simulated investment performance to actual performance for the investment over the same duration of time; and
code configured to cause the computing device to request adjustment of the model to reduce any disparity between the simulated investment performance and the actual investment performance.

12. The computer program product of claim 11, wherein the model elements comprise one or more financial instruments.

13. The computer program product of claim 12, wherein the code configured to cause the computing device to request creation of a model element further comprises code configured to cause the computing device to request identification of the one or more financial instruments.

14. The computer program product of claim 12, wherein the code configured to cause the computing device to request adjustment of the model further comprises code configured to cause the computing device to request changes to at least one of the one or more financial instruments in a model element and to re-simulate performance for the investment utilizing the model.

15. The computer program product of claim 11, further comprising code configured to cause the computing device to present the simulated investment performance in conjunction with the actual investment performance.

16. The computer program product of claim 15, further comprising code configured to cause the computing device to present analysis of disparities between the simulated investment performance and the actual investment performance.

17. The computer program product of claim 11, further comprising code configured to cause the computing device to create a portfolio, the portfolio comprising one or more investments.

18. The computer program product of claim 17, wherein the code configured to cause the apparatus to create the portfolio further comprises code configured to cause the computing device to create a model for each investment in the portfolio and to present simulated investment performance for the portfolio in conjunction with actual portfolio performance.

19. The computer program product of claim 18, further comprising code configured to cause the computing device to present analysis of disparities between the simulated portfolio performance and actual portfolio performance.

20. An apparatus, comprising:
a processor; and
a memory comprising executable instructions, the memory and the executable instructions being configured to, in conjunction with the processor, cause the apparatus to perform the following:
request identification of an investment, the investment comprising one or more components;
request determination of whether each of the one or more components are known or unknown;
formulate a model of the investment by requesting entering of the known components into the model of the investment;
request creation of a model element corresponding to each unknown component and entry of the model element into the model of the investment;
simulate performance for the investment utilizing the model of the investment;
compare the simulated investment performance to actual performance for the investment over the same duration of time; and
request adjustment of the model to reduce any disparity between the simulated investment performance and the actual investment performance.

21. The apparatus of claim 20, wherein the model elements comprise one or more financial instruments.

22. The apparatus of claim 21, wherein the memory and the executable instructions being configured to, in conjunction with the processor, cause the apparatus to request creation of the model element further comprises the memory and the executable instructions being configured to, in conjunction with the processor, cause the apparatus to request selection the one or more financial instruments.

23. The apparatus of claim 21, wherein the memory and the executable instructions being configured to, in conjunction with the processor, cause the apparatus to request adjustment of the model further comprises the memory and the executable instructions being configured to, in conjunction with the processor, cause the apparatus to request changes to at least one of the one or more financial instruments in a model element and to re-simulate performance for the investment utilizing the model.

24. The apparatus of claim 20, further comprising the memory and the executable instructions being configured to, in conjunction with the processor, cause the apparatus to present the simulated investment performance in conjunction with the actual investment performance.

25. The apparatus of claim 24, further comprising the memory and the executable instructions being configured to, in conjunction with the processor, cause the apparatus to present analysis of disparities between the simulated investment performance and the actual investment performance.

26. The apparatus of claim 20, further comprising the memory and the executable instructions being configured to, in conjunction with the processor, cause the apparatus to create a portfolio, the portfolio comprising one or more investments.

27. The apparatus of claim 26, wherein the memory and the executable instructions being configured to, in conjunction with the processor, cause the apparatus to create the portfolio further comprises the memory and the executable instructions being configured to, in conjunction with the processor, cause the apparatus to create a model for each investment in the portfolio and to present simulated investment performance for the portfolio in conjunction with actual portfolio performance.

28. The apparatus of claim 27, further comprising the memory and the executable instructions being configured to, in conjunction with the processor, cause the apparatus to present analysis of disparities between the simulated portfolio performance and actual portfolio performance.
